(19) United States
(12) Patent Application Publication
(10) Pub. No.: US 2013/0159795 A1
(43) Pub. Date: Jun. 20, 2013

(54) INTEGRATED CIRCUIT, FAULT INFORMATION PROCESSING METHOD AND FAULT INFORMATION COLLECTION APPARATUS

(71) Applicant: FUJITSU LIMITED, Kawasaki-shi (JP)

(72) Inventors: Seiji SATTA, Fujisawa (JP); Akira Okamoto, Kawasaki (JP); Hideyuki Sakamaki, Yokohama (JP); Yoshikazu Iwami, Inagi (JP); Takumi Nonaka, Kawasaki (JP); Hidekazu Osano, Hachioji (JP)

(73) Assignee: FUJITSU LIMITED, Kawasaki-shi (JP)

(21) Appl. No.: 13/761,210

(22) Filed: Feb. 7, 2013

Related U.S. Application Data
(63) Continuation of application No. PCT/JP2010/063656, filed on Aug. 11, 2010.

(51) Int. Cl. G06F 11/07

(52) U.S. Cl. CPC G06F 11/0772
USPC 714/57

(57) ABSTRACT

An integrated circuit includes a fault collection section, and a plurality of modules. Each of the modules includes a fault detection section that detects a fault in the modules, a fault information generation section that generates fault information about the detected fault, a notification section that issues a fault detection notification indicating that a fault is detected to the fault collection section, and a first transmission section that transmits the fault information to the fault collection section. The fault collection section includes a specification section that specifies, based on the fault detection notification, the module from which the fault detection notification has been received first from among the modules, and an acquisition section that acquires the fault information from the module specified by the specification section.

### CROSS-REFERENCE TO RELATED APPLICATIONS

This application is a continuation application of International Application No. PCT/JP2010/63656, filed on Aug. 11, 2010 and designated the U.S., the entire contents of which are incorporated herein by reference.

### FIELD

The embodiment discussed herein is directed to a fault information processing method for an integrated circuit.

### BACKGROUND

A technology is known that, where an error (fault) occurs in the inside of an LSI (Large Scale Integration) or the like, information relating to the error is collected and the error is analyzed by a special operator based on the collected information.

Here, operation of a system where an error occurs in the inside of an LSI or the like is described with reference to FIGS. 7 and 8. FIG. 7 is a view depicting a hardware configuration of a system 100. The system 100 includes an LSI 200 and a system controller 300. The LSI 200 includes a plurality of error detection modules 210 for detecting an error in the LSI 200 and an error collection module 220 for issuing a notification of occurrence of an error to the system controller 300. It is to be noted that the error detection modules 210 are included in sub modules for implementing a specific function, respectively.

FIG. 8 is a flow chart illustrating operation of the system 100 when an error occurs. First, if an error occurs in the LSI 200, then an error detection module 210 detects the error and issues a notification that the error is detected to the error collection module 220 (step B1).

The error collection module 220 receives the notification and reports that an error has occurred in the LSI 200 to the system controller 300 (step B2). The system controller 300 receives the information and collects information from storage sections such as registers of all of the error detection modules 210 (step B3), and a manager of the system 100 or the like would execute an analysis based on the collected information (step B4). After the analysis ends, the system controller 300 clears the information stored in the storage sections such as registers of all of the error detection modules 210 (step B5).
[Patent Document 1] Japanese Laid-Open Patent Publication No. Hei 6-149630

However, as the circuit scale of the LSI 200 increases, the number of sub modules increases. In particular, since the number of the error detection modules 210 increases, the system controller 300 must collect information from a great number of registers of the error detection modules 210 in order to analyze an error. Therefore, there is a problem that much time is required for the collection of information, and as a result, much time is required for an analysis of the error.

### SUMMARY

According to the embodiment, there is provided an integrated circuit including a fault collection section, and a plurality of modules, wherein each of the modules includes a fault detection section that detects a fault in the modules, a fault information generation section that generates, when a fault is detected by the fault detection section, fault information about the detected fault, and a notification section that issues, when a fault is detected by the fault detection section, a fault detection notification indicating that a fault is detected to the fault collection section, and the fault collection section includes a specification section that specifies, based on the fault detection notification, the module from which the fault detection notification has been received first from among the modules, and an acquisition section that acquires the fault information from the module specified by the specification section.

According to the embodiment, there is further provided a fault information processing method for an integrated circuit that includes a fault collection section and a plurality of modules, wherein each of the modules executes detecting a fault in the module, generating, when a fault is detected upon the fault detection, fault information about the detected fault, and issuing, when a fault is detected upon the fault detection, a fault detection notification indicating that a fault is detected to the fault collection section, and the fault collection section executes specifying, based on the fault detection notification, the module from which the fault detection notification is issued first from among the modules, and acquiring the fault information from the module specified upon the specification.

According to the embodiment, there is further provided a fault information collection apparatus that collects a fault from a plurality of modules each including a fault detection section that detects a fault, a fault information generation section that generates, when a fault is detected by the fault detection section, fault information about the detected fault, and a notification section that issues, when a fault is detected by the fault detection section, a fault detection notification indicating that a fault is detected to a fault collection section, the fault information collection apparatus including a specification section that specifies, based on the fault detection notification, the module from which the fault detection notification is received first from among the modules, and an acquisition section that acquires the fault information from the module specified by the specification section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting a configuration of a system as an example of an embodiment;

FIG. 2 is a view depicting a configuration of a sub module and an error collection module as an example of the embodiment;

FIG. 3 is a view depicting a detailed configuration of the sub module and the error collection module as an example of the embodiment;

FIG. 4 is a view depicting processed error information as an example of the embodiment;

FIG. 5 is a view depicting a configuration of a system controller as an example of the embodiment;

FIG. 6 is a flow chart illustrating a fault processing method of the system as an example of the embodiment;

FIG. 7 is a view depicting a hardware configuration of a system including an LSI; and

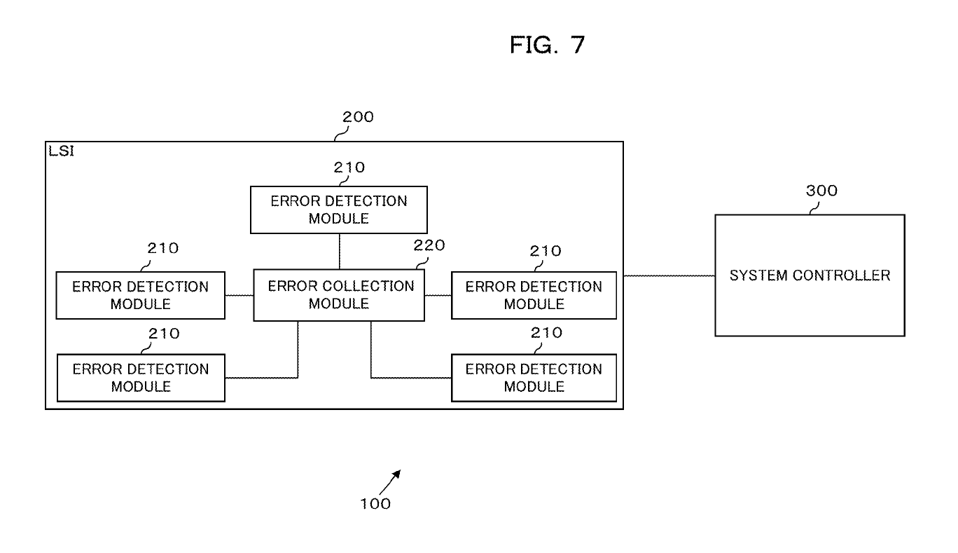

FIG. 8 is a flow chart illustrating operation of the system where an error occurs.

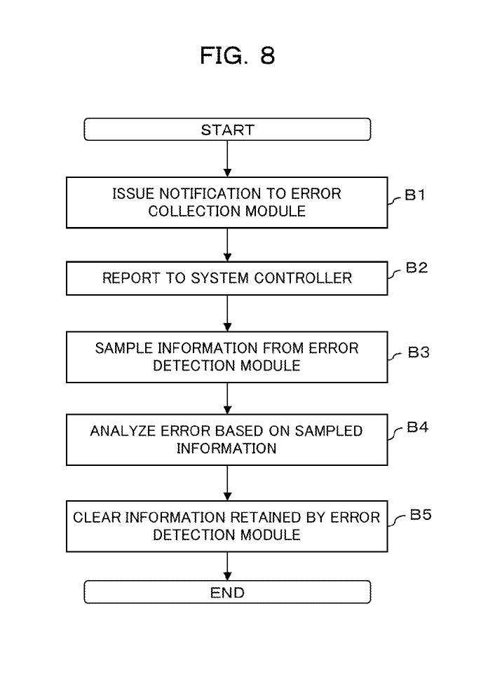

### DESCRIPTION OF EMBODIMENT

In the following, an example of an embodiment relating to an integrated circuit, a fault information processing method and a fault information collection apparatus is described with reference to the drawings.

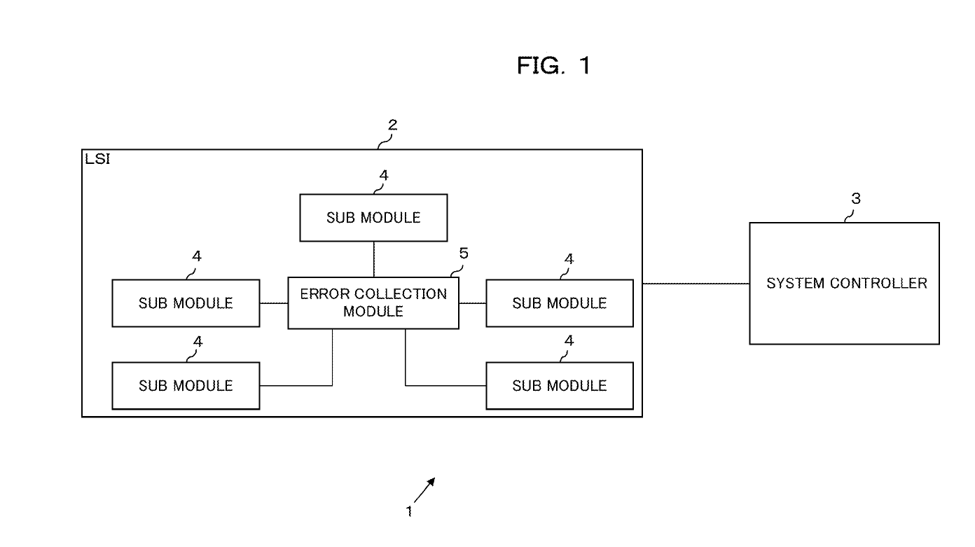

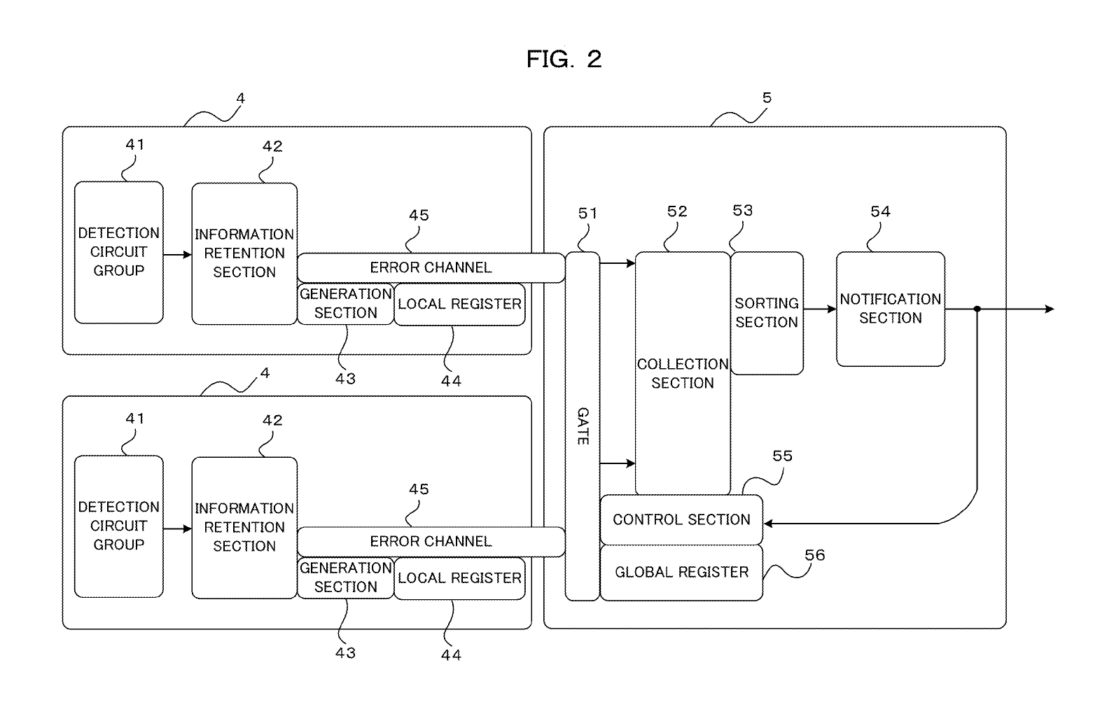

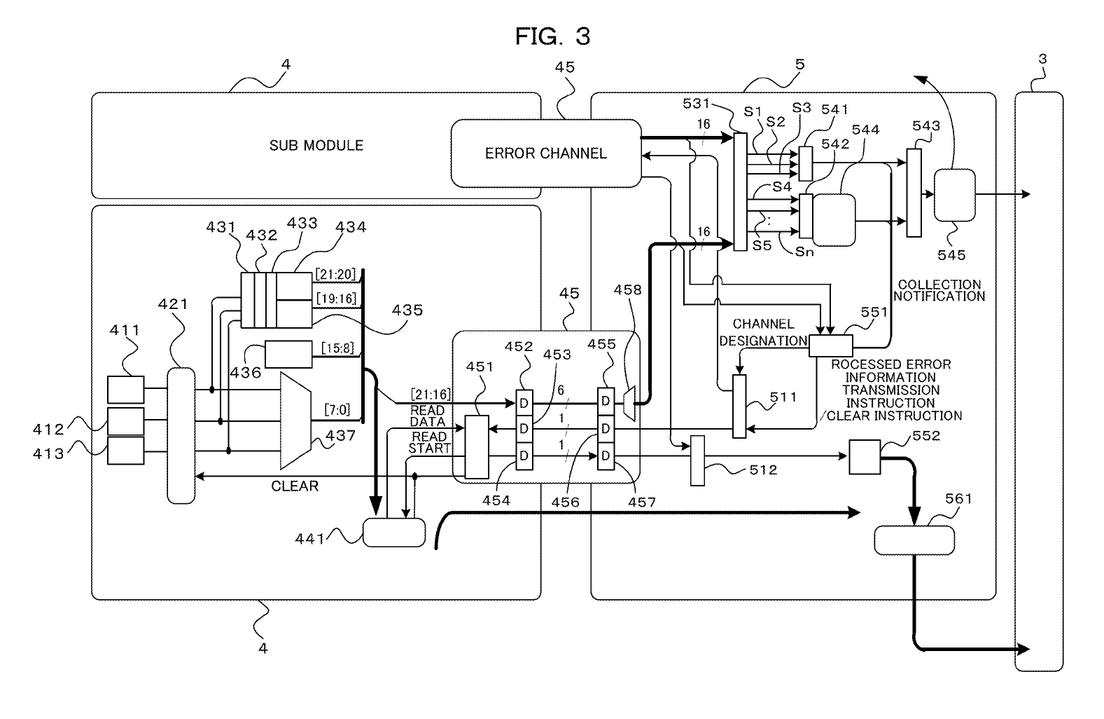

FIG. 1 is a view depicting a configuration of a system as an example of the embodiment; FIG. 2 is a view depicting a configuration of a sub module and an error collection module as an example of the embodiment; and FIG. 3 is a view depicting a detailed configuration of the sub module and the error collection module as an example of the embodiment. It is to be noted that, in FIG. 2, blocks depicted in contact with each other indicate that they are connected for communication to each other. For example, it is indicated in FIG. 2 that an information retention section 42 is connected to a generation section 43 for communication.

As depicted in FIG. 1, the system 1 as an example of the present embodiment includes an LSI (integrated circuit) 2 and a system controller (external apparatus) 3. The LSI 2 and the system controller 3 are connected for communication to each other through a bus or the like.

The LSI 2 is, for example, a processing circuit having a specific function, and includes, in the example of the present embodiment, a plurality of (in the example depicted in FIG. 1, five) sub modules 4 and an error collection module (an example of a fault collection section) 5.

Each sub module 4 is a module for implementing a function of an LSI. As illustrated in FIG. 2, the sub module 4 includes not only a circuit (not depicted) for implementing the function but also a detection circuit group 41, an information retention section 42, a generation section 43, a local register 44 and an error channel 45.

It is to be noted that, in an example depicted in FIG. 2, only two sub modules 4 are illustrated for the convenience of illustration while illustration of the remaining sub modules 4 is omitted.

The detection circuit group 41 detects an error in the sub module 4 and outputs error information. The detection circuit group 41 includes, for example, a plurality of circuits for detecting a fault in the sub module 4. For example, the circuits for detecting a fault in the sub module 4 detect faults different from each other in the sub module 4, and, when a fault is detected, a flag indicating that a fault is detected is set. In particular, the detection circuit group 41 outputs error information in which the flag is set at a different position depending upon the kind of the fault.

In the example depicted in FIG. 3, error detection circuits 411 to 413 correspond to the detection circuit group 41 of FIG. 2. While the detection circuit group 41 includes the three error detection circuits 411 to 413 in the example depicted in FIG. 3, the present disclosure is not limited to this.

Each of the error detection circuits 411 to 413 detects a specific fault in the sub module 4 and outputs, when a fault is detected, a flag indicating that a fault is detected. In particular, the error detection circuits 411 to 413 function as fault detection sections for detecting a fault in the module. It is to be noted that a function for detecting a specific fault can be implemented by using various known methods, and detailed description of the methods is omitted.

The information retention section 42 is, for example, a register and retains error information outputted from the detection circuit group 41. In the example depicted in FIG. 3, an information retention section 421 corresponds to the information retention section 42 of FIG. 2.

The information retention section 421 is, for example, a register and retains outputs from the error detection circuits 411 to 413.

The generation section 43 carries out a process for the error information retained by the information retention section 42 to generate formatted error information (hereinafter referred to sometimes and simply as processed error information) and stores the generated information into the local register 44. In particular, the generation section 43 functions as a fault information generation section that generates fault information (processed error information).

Further, the generation section 43 issues a notification of part (in the example of the present embodiment, an error level and an error type hereinafter described) of the processed error information to the error collection module 5. The notification is hereinafter referred to sometimes as error notification or fault detection notification. In particular, the generation section 43 functions as a notification section that issues a fault detection notification indicating that a fault is detected to the fault collection section.

It is to be noted that the generation section 43 carries out a process for an error detected first by the detection circuit group 41 in the sub module 4 to generate processed error information. Here, “first” in the present specification signifies a state after the system 1 is started up or another state after processed error information retained by a global register 56 and the local register 44 and error information retained by the information retention section 42 are cleared as hereinafter described.

In the example depicted in FIG. 3, a grouping section 431, a priority section 432, a first encoding section 433, an error level outputting section 434, an error type outputting section 435, a module code outputting section 436 and a second encoding section 437 correspond to the generation section 43 of FIG. 2.

The grouping section 431 carries out, for example, grouping of error information retained by the information retention section 421. In particular, the grouping section 431 carries out classification of the error information in response to that one of the error detection circuits 411 to 413 by which the error is detected. For example, a case is considered that error information indicating that faults are detected at the same time by the error detection circuit 411 and the error detection circuit 412 is retained by the information retention section 42. In this instance, the grouping section 431 classifies the error information into error information indicating the fault detected by the error detection circuit 411 and error information indicating the fault detected by the error detection circuit 412.

The priority section 432 carries out, for example, priority ranking for error information classified by the grouping section 431. For example, the priority section 432 applies a higher priority rank to error information indicating a fault detected by the error detection circuit 411 than a priority rank to error information indicating a fault detected by the error detection circuit 412.

The first encoding section 433 encodes error information to which the highest priority rank is applied by the priority section 432 to generate an error level indicating a degree of importance of the error. For example, if the highest priority rank is applied to error information indicating a fault detected by the error detection circuit 411, then the first encoding section 433 encodes the error information indicating the fault detected by the error detection circuit 411.

Further, the first encoding section 433 can also encode the error information to which the highest priority rank is applied by the priority section 432 to generate an error type indicating a kind of the error.

The error level outputting section 434 outputs an error level generated, for example, by the first encoding section 433.

The error type outputting section 435 outputs an error type generated by, for example, the first encoding section 433.

The module code outputting section 436 outputs a module number for identifying each of the sub modules 4. The module numbers are fixed values determined in advance for the individual sub modules 4.

The second encoding section 437 encodes error information retained by the information retention section 421 to generate and output detailed information. Here, the detailed information is information indicating detailed contents of the error. Further, if the error information retained by the information retention section 421 indicates that a plurality of errors are detected at the same time by the detection circuit group 41, then the second encoding section 437 includes the information indicating that the plural errors have occurred at the same time into the detailed information.

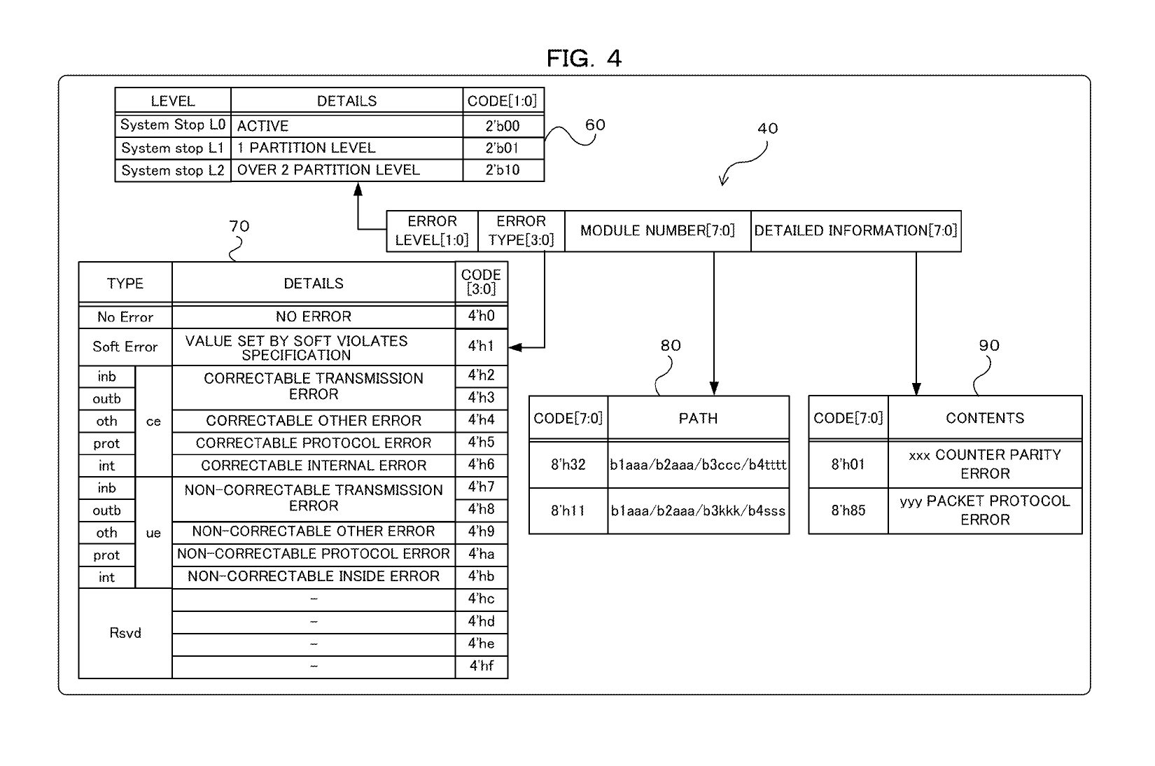

FIG. 4 is a view illustrating processed error information as the example of the embodiment.

Processed error information 40 includes an error level, an error type, a module number and detailed information described hereinabove.

In the example illustrated in FIG. 4, the error level, error type, module number and detailed information are represented by 2 bits, 4 bits, 8 bits and 8 bits, respectively. Here, if a plurality of errors are detected at the same time by the detection circuit group 41, then, for example, the second encoding section 437 records “1” as information indicating that a plurality of errors have occurred at the same time into a predetermined position (for example, the most significant bit) of the detailed information represented by 8 bits.

It is to be noted that, as illustrated in a table 60, the error level (“code” in the table 60) represented by 2 bits is associated with the information (“level” in the table 60) indicating the error level and details (“details” in the table 60) of the error level. For example, a code “2′b01” indicated in the table 60 represents that the error level is “System stop L1” and details of the error level are “1 partition level”. In particular, the code “2′b01” indicated in the table 60 represents that an error has occurred in the partition of one. Further, for example, a code “2′b00” indicated in the table 60 represents that the error level is “System stop L0” and details of the error level are “active”. In particular, the code “2′b00” indicated in the table 60 represents that an error to be issued as a notification to the system controller 3 does not occur. Here, 2′b indicates that 2-bit data is represented by a binary number.

Further, as illustrated in a table 70, the error type (“code” in the table 70) represented by 4 bits is associated with information (“type” in the table 70) indicating the error type and the details (“details” in the table 70) of the error type. For example, a code “4′h1” indicated in the table 70 represents that the error type is “int_ce” and details of the error type are “correctable inside error”. Further, for example, a code “4′h0” indicated in the table 70 represents that the error type is “No Error” and details of the error type are “no error”. In particular, the code “4′h0” indicated in the table 70 represents that an error to be issued as a notification to the system controller 3 does not occur. It is to be noted that codes “ce” and “ue” in the table 70 signify a correctable error and an uncorrectable error, respectively. Here, 4′h indicates that 4-bit data is represented by a hexadecimal number.

Further, as illustrated in a table 80, the module number (“code” in the table 80) represented by 8 bits is associated with a path (“path” in the table 80) to the sub module 4. For example, codes “8′h32” and “8′h11” in the table 80 indicate paths “b1aaa/b2aaa/b3 ccc/b4ttt” and “b1aaa/b2aaa/b3kkk/b4sss”, respectively. Here, 8′h indicates that 8-bit data is represented by a hexadecimal number.

Further, as illustrated in a table 90, the detailed information (“code” in the table 90) represented by 8 bits is associated with contents (“contents” in the table 90) of the detailed information. For example, codes “8′h01” and “8′h85” in the table 90 indicate “xxx counter parity error” and “yyy packet protocol error”, respectively.

It is to be noted that the tables 60, 70, 80 and 90 are not limited to them. Further, for the convenience of description, part of the tables 60, 70, 80 and 90 is omitted.

The local register 44 is a register and stores processed error information generated by the generation section 43. In particular, the local register 44 functions as a first retention section that retains fault information.

In the example depicted in FIG. 3, a local register 441 corresponds to the local register 44 of FIG. 2.

The local register 441 retains, as processed error information, outputs of the error level outputting section 434, error type outputting section 435, module code outputting section 436 and second encoding section 537. Further, the local register 441 is connected for communication, for example, to a transmission section 451 hereinafter described and retains the processed error information so as to be readable by the transmission section 451.

The error channel 45 connects the sub module 4 and the error collection module 5 for communication to each other.

In the example depicted in FIG. 3, the transmission section 451, D flip-flops (Delay flip-flops) 452 to 457 and a decoding section 458 correspond to the error channel 45 of FIG. 2. In the example depicted in FIG. 3, the sub module 4 includes the transmission section 451 and the D flip-flops 452 to 454, and the error collection module 5 includes the D flip-flops 455 to 457 and the decoding section 458. Further, the transmission section 451 is connected for communication to the D flip-flops 453 and 454, local register 441 and information retention section 421. Further, the D flip-flops 452 to 454 and the D flip-flops 455 to 457 are connected for communication to each other, respectively. Further, the decoding section 458 is connected for communication to the D flip-flop 455 and an error grouping section 531 hereinafter described. Further, the D flip-flop 452 is connected for communication to the error level outputting section 434 and the error type outputting section 435. Further, the D flip-flops 456 and 457 are connected for communication to a selector 511 and an OR circuit 512 hereinafter described, respectively.

The transmission section 451 reads out processed error information from the local register 441, for example, in response to an instruction from a control section 551 hereinafter described and transmits the read out information to the error collection module 5 through the D flip-flops 454 and 457. Further, the transmission section 451 clears the information retained by the information retention section 421 and the local register 441 in response to an instruction from the control section 551. In particular, the transmission section 451 functions as a first transmission section that transmits fault information to the fault collection section.

The D flip-flops 452 to 457 are provided, for example, in order to implement timing relaxation. It is to be noted that, in the example of the present embodiment, the D flip-flop 452 and the D flip-flop 455 are connected to each other by a bus having a 6-bit width. Further, for example, the D flip-flops 453 and 454 are connected to the D flip-flops 456 and 457 by buses having a 1-bit width, respectively. It is to be noted that the error channel 45 may not include the D flip-flops 452 to 457.

The decoding section 458 decodes, for example, an error notification issued from the error level outputting section 434 and the error type outputting section 435 and outputs a result of the decoding to the error grouping section 531 hereinafter described and the control section 551 hereinafter described.

The error collection module 5 collects processed error information from the sub modules 4 and transmits the collected information to the system controller 3. In particular, for example, the error collection module 5 decides the sub module 4 from which the error notification has been issued first from among the sub modules 4, and collects the processed error information retained by the local register 44 of the sub module 4 from which the error notification has been issued first.

In the example of the present embodiment, as depicted in FIG. 2, the error collection module 5 includes a gate 51, a collection section 52, a sorting section 53, a notification section 54, a control section 55 and a global register 56.

The collection section 52 bundles error notifications from the sub modules 4. In the example depicted in FIG. 3, the collection section 52 corresponds to a path for connecting the error channel 45 and the error grouping section 531 hereinafter described and controller 551 to each other.

The sorting section 53 carries out grouping of error notifications, for example, from the sub modules 4. In particular, the sorting section 53 carries out the grouping, for example, for each error level and each error type.

In the example depicted in FIG. 3, the error grouping section 531 corresponds to the sorting section 53 of FIG. 2.

The error grouping section 531 receives error notifications inputted from the sub modules 4 and carries out grouping of the error notifications from the sub modules 4 for each error level and each error type. The error grouping section 531 outputs a result of the grouping carried out for each error level and another result of the grouping carried out for each error type to a first priority section 541 hereinafter described and a second priority section 542 hereinafter described, respectively. In FIG. 3, reference characters S1 to S3 indicate paths along which signals representing error levels sorted by the error grouping section 531 and different from each other are transmitted. Further, in FIG. 3, reference characters S4 to Sn (n is a natural number) indicate paths along which signals representing error types sorted by the error grouping section 531 and different from each other are transmitted.

The notification section 54 issues a notification (hereinafter referred to simply as collection notification) that an error about which processed error information is to be collected occurs to the system controller 3 and the control section 55 hereinafter described, for example, based on error notification grouped by the sorting section 53.

In the example depicted in FIG. 3, the first priority section 541, the second priority section 542, an OR circuit 543, a review register 544 and a warning register 545 correspond to the notification section 54 of FIG. 2.

The first priority section 541 carries out, for example, priority ranking for a plurality of error levels classified by the error grouping section 531. The first priority section 541 applies a higher priority rank, for example, to a serious error. For example, if an error level to which the highest priority rank is applied is equal to or higher than a predetermined threshold value, then the first priority section 541 outputs the error level as a collection notification to the OR circuit 543 and the control section 55. On the other hand, if the error level to which the highest priority rank is applied is lower than the predetermined threshold value, then the first priority section 541 outputs a value (for example, “0”) indicating that an error with which the processed error information is to be collected does not occur to the OR circuit 543 and the control section 55. In particular, if the error level having the highest priority rank is equal to or higher than the predetermined threshold value, then the first priority section 541 outputs a collection notification to the OR circuit 543 and the control section 55. On the other hand, if the error level having the highest priority rank is lower than the predetermined threshold value, then the first priority section 541 does not output a collection notification to the OR circuit 543 and the control section 55.

Accordingly, the manager of the system 1 or the like can set the threshold value of the error level to an arbitrary value to control the output of the first priority section 541.

The second priority section 542 carries out priority ranking, for example, for a plurality of error types classified by the error grouping section 531. The second priority section 542 applies a higher rank, for example, to a serious error. It is to be noted that an error type to which a priority rank is applied by the second priority section 542 is recorded into the error review register 544. The second priority section 542 can also output the error type having the highest priority rank as collection notification to the OR circuit 543 and the control section 55.

The OR circuit 543 calculates, for example, an OR value between the output of the first priority section 541 and the output of the second priority section 542 and issues a result of the calculation as a notification to the system controller 3. It is to be noted that the output of the OR circuit 543 is recorded, for example, into the warning register 545.

For example, if a collection notification is received from the notification section 54, then the control section 55 decides a sub module 4 from which the error notification has been issued first from among the sub modules 4. It is to be noted that, if error notifications are received at the same time from plural sub modules 4, then the control section 55 decides, for example, a sub module 4 which carries out the error notification including the highest error level from among the error notifications as a sub module 4 from which the error notification has been issued first. In other words, the control section 55 functions as a specification section that specifies a module from which a fault detection notification has been issued first from among a plurality of modules.

Further, if a collection notification is received from the notification section 54, then the control section 55 issues an instruction to the transmission section 451 to transmit the processed error information from the local register 44 of the sub module 4 from which the error notification has been issued first to acquire the processed error information. In other words, the control section 55 functions as an acquisition section that acquires fault information from the module specified by the specification section.

Further, if an instruction to transmit the processed error information to the system controller 3 is received from the system controller 3, then the control section 55 reads out the processed error information from the global register 56 and transmits the read out information to the system controller 3. In other words, the control section 55 functions as a second transmission section that transmits fault information to the external apparatus.

Further, the control section 55 receives an instruction (hereinafter referred to simply and sometimes as clear instruction) to clear the processed error information retained by the global register 56 and the local register 44 and the error information retained by the information retention section 42 from the system controller 3. If the clearing instruction is received from the system controller 3, then the control section 55 issues an instruction to the transmission section 451 to clear the information retained by the information retention section 42 and the local register 44 and clear the processed error information retained by the global register 56.

It is to be noted that, in the example depicted in FIG. 3, the control section 551 and a conversion section 552 correspond to the control section 55 of FIG. 2.

The control section 551 receives, for example, error notifications inputted thereto from the sub modules 4. The control section 551 decides a sub module 4 from which the error notification has been issued first from among the sub modules 4, for example, using the output of the first priority section 541 or the review register 544, namely, the output (collection notification) of the second priority section 542, as a trigger. Further, for example, using the output of the first priority section 541 or the review register 544, namely, the output of the second priority section 542, as a trigger, the control section 551 issues an instruction to the transmission section 451 of the sub module 4 from which the error notification has been issued first to transmit the processed error information from the local register 441.

In particular, the control section 551 issues an instruction (channel instruction) to the selector 511 hereinafter described to connect the control section 551 and the error channel 45 included in the sub module 4 from which the error notification has been issued first for communication to each other. Thereafter, the control section 551 issues an instruction to the transmission section 451 included in the sub module 4 from which the error notification has been issued first to transmit the processed error information from the local register 441.

It is to be noted that, for example, a flag is set at positions different from each other for the individual sub modules 4 when the error notifications are received, and the control section 551 decides the sub module 4 from which the error notification has been issued first from among the sub modules 4 based on the position of the flag. It is to be noted that the control section 551 includes, for example, a memory into which the flags can be set.

The conversion section 552 is, for example, a serial/parallel converter and carries out serial/parallel conversion of the processed error information transmitted thereto from the transmission section 451 and stores the resulting information into the global register 56.

The gate 51 changes over the error channel 45 to be connected to the control section 55, for example, in response to an instruction from the control section 55.

In the example depicted in FIG. 3, the selector 511 and the OR circuit 512 correspond to the gate 51 of FIG. 2.

The selector 511 changes over the error channel 45 to be connected to the control section 551 in response to an instruction from the control section 551. In particular, the selector 511 changes over the error channel 45 to be connected to the control section 551 in response to the instruction from the control section 551.

The OR circuit 512 calculates logical ORing of processed error information transmitted thereto from the sub modules 4. It is to be noted that, since there is no case wherein processed error information is transmitted at the same time from plural ones of the sub modules 4, processed error information is inputted from one sub module 4 to the OR circuit 512 while the signals from the remaining sub modules 4 are not inputted (in particular, “0” is inputted).

The global register 56 is a register and retains processed error information read out and transmitted from the local register 44 by the transmission section 451. In particular, the global register 56 functions as a second retention section that retains fault information.

In the example depicted in FIG. 3, a global register 561 corresponds to the global register 56 of FIG. 2.

The global register 561 stores processed error information after conversion from a serial signal into a parallel signal by the conversion section 552 therein.

The system controller 3 receives processed error information, for example, from the error collection module 5 and carries out an analysis of an error based on the received processed error information.

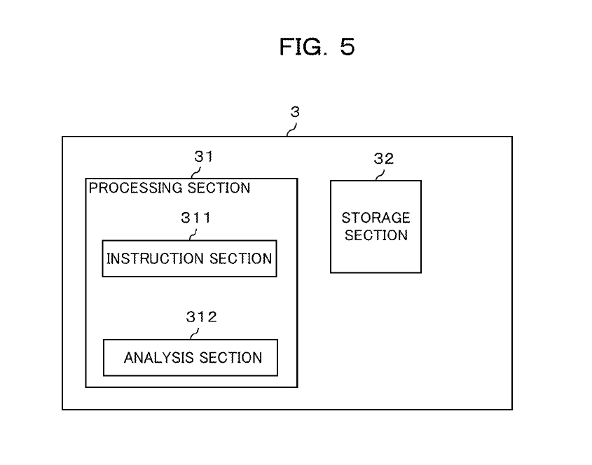

FIG. 5 is a view depicting a configuration of the system controller 3. As depicted in FIG. 5, the system controller 3 includes a processing section 31 and a storage section 32.

The storage section 32 is a storage device such as, for example, a ROM (Read Only Memory) or a RAM (Random Access Memory) and stores various kinds of information therein.

The processing section 31 is a processing device for executing, for example, various application programs stored in the storage section 32 to carryout various kinds of arithmetic operation or control to implement various functions.

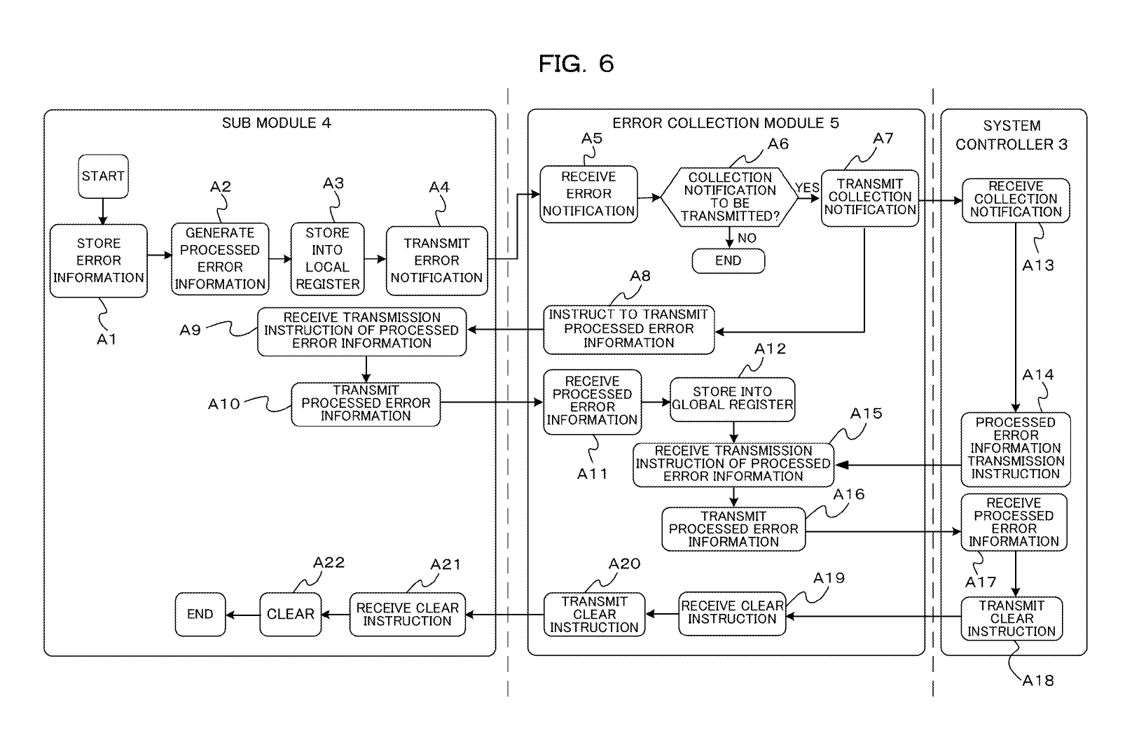

For example, the processing section 31 functions as an instruction section 311 and an analysis section 312 as depicted in FIG. 6 by executing an application program.

For example, if the system controller 3 receives collection notification from the OR circuit 543, then the instruction section 311 carries out instruction to the control section 55 to transmit processed error information in order to acquire the processed error information.

Further, the instruction section 311 carries out, for example, instruction to the control section 55 to clear processed error information retained by the global register 56 and the local register 44 and error information retained by the information retention section 42.

The analysis section 312 carries out an analysis of an error, for example, based on processed error information transmitted by the control section 55. It is to be noted that the analysis section 312 can be implemented by various known methods, and detailed description of the methods is omitted.

A fault information processing method for the system 1 as the example of the embodiment configured in such a manner as described above is described with reference to a flow chart (steps A1 to A22) depicted in FIG. 6.

First, if an error occurs in an arbitrary sub module 4, then the detection circuit group 41 detects the error and outputs error information and then stores the error information into the information retention section 42 (step A1). Then, based on the error information, the generation section 43 generates processed error information (step A2) and stores the processed error information into the local register 44 (step A3). Further, the generation section 43 issues an error notification to the error collection module 5 (step A4). The error collection module 5 receives the error notification decoded by the error channel 45 (step A5). After the error collection module 5 receives the error notification, the notification section 54 decides whether or not a collection notification is to be transmitted based on the error notifications obtained by carrying out grouping for each error level and each error type by the sorting section 53 (step A6). For example, if the error level included in the error notification is equal to or higher than the predetermined threshold value (refer to a YES route of step A6), then the notification section 54 issues a collection notification to the system controller 3 and the control section 55 (step A7). The control section 55 receives the collection notification and decides a sub module 4 from which the error notification has been issued first from among the sub modules 4, and then issues an instruction to the gate 51 to connect the control section 55 and the error channel 45 of the sub module 4 from which the error notification has been issued first to each other. Then, the gate 51 connects the control section 55 and the error channel 45 of the sub module 4 from which the error notification has been issued first to each other. The control section 55 issues an instruction to the transmission section 451 included in the sub module 4 from which the error notification has been issued first to transmit the processed error information (step A8). After the instruction is received from the control section 55 (step A9), the transmission section 451 reads out the processed error information from the local register 44 and transmits the read out information to the error collection module 5 through the error channel 45 (step A10). After the error collection module 5 receives the processed error information (step A11), the control section 55 stores the processed error information into the global register 56 (step A12).

On the other hand, if the collection notification is received (step A13), then the system controller 3 issues an instruction to the control section 55 to transmit the processed error information to the system controller 3 (step A14). When the instruction is received from the system controller 3 (step A15), the control section 55 reads out the processed error information from the global register 56 and transmits the read out information to the system controller 3 (step A16). When the processed error information is received (step A17), the system controller carries out an analysis of the processed error information. Thereafter, the system controller 3 issues an instruction to the control section 55 to clear the information retained by the global register 56, local register 44 and information retention section 42 (step A18). When the instruction from the system controller 3 is received (step A19), the control section 55 clears the information retained by the global register 56 and issues an instruction to the gate 51 to connect the control section 55 and the error channels 45 of all sub modules 4 to each other. Then, the control section 55 issues an instruction to all of the sub modules 4, particularly to the transmission sections 451, to clear the information retained by the local register 44 and the information retention section 42 (step A20). When the instruction from the control section 55 is received (step A21), the transmission section 451 clears the information retained by the local register 44 and the information retention section 42 (step A22).

It is to be noted that, if it is decided at step A6 that collection notification is not to be issued (refer to No route at step A6), then the processing is ended without carrying out the collection notification.

In this manner, with the system 1 as the example of the embodiment, the error collection module 5 decides a sub module 4 from which the error notification has been issued first to the error collection module 5 from among the sub modules 4. Then, the error collection module 5 acquires processed error information from the sub module 4 from which the error notification has been issued first to the error collection module 5. Consequently, only if the processed error information retained by the error collection module 5 is acquired for the analysis of a cause of an error, unnecessary information need not be acquired. Accordingly, time required for information collection for an error analysis can be reduced significantly.

Further, since the system controller 3 acquires processed error information from the error collection module 5 and carries out an error analysis based on the acquired processed error information, the system controller 3 need not read out the registers of all sub modules 4 in the LSI 2, and as a result, time required for the error analysis can be reduced significantly.

Further, with the system 1 as the example of the embodiment, the generation section 43 generates processed error information based on an error detected first by the detection circuit group 41. Then, the system controller 3 carries out an error analysis based on the processed error information acquired from the sub module 4 from which the error notification has been issued first to the error collection module 5. Accordingly, by the error analysis, a cause of the error can be specified with certainty.

It is to be noted that the present embodiment is not limited to the embodiment specifically described above, and variations and modifications can be made without departing from the scope of the present embodiment.

For example, while, in the example of the present embodiment, the generation section 43 issues a notification of an error level and an error type as an error notification to the error collection module 5, the present embodiment is not limited to this. For example, the generation section 43 may issue a notification only of an error level as an error notification to the error collection module 5.

Further, while, in the example of the present embodiment, the generation section 43 generates an error level based on error information to which the highest priority rank is applied by the priority section 432 and generates processed error information having the generated error level, the present embodiment is not limited to this.

For example, if a plurality of errors occur at the same time in the sub modules 4, then, for example, a plurality of error levels may be generated from higher ones of the priority ranks applied by the priority section 432 such that the generation section 43 generates processed error information for each of the error levels. It is to be noted that, in this instance, also in regard to the error type, a plurality of error levels are generated from higher ones of the priority ranks applied by the priority section 432.

Further, while the error collection module 5 includes the OR circuit 512, a selector for selectively connecting the error channel 45 and the conversion section 55 to each other may be used in place of the OR circuit 512. It is to be noted that changeover of the selector is carried out based on channel designation inputted from the control section 55 to the selector 511.

Further, where the processed error information includes information indicating that a plurality of errors occur at the same time in the sub modules 4, the system controller 3 may acquire the error information from the information retention section 42 of the sub module 4, for example, through a system bus not depicted or the like.

Further, while, in the example of the present embodiment, the system controller 3 carries out an error analysis based on the processed error information, the present embodiment is not limited to this. For example, the manager of the system 1 may acquire and analyze the processed error information.

With the integrated circuit, fault information processing method and fault information collection apparatus of the present disclosure, time required for an analysis of a fault can be reduced significantly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An integrated circuit, comprising:
a fault collection section; and
a plurality of modules; wherein
each of the modules includes:
a fault detection section that detects a fault in the modules;
a fault information generation section that generates, when a fault is detected by the fault detection section, fault information about the detected fault; and
a notification section that issues, when a fault is detected by the fault detection section, a fault detection notification indicating that a fault is detected to the fault collection section; and
the fault collection section includes:
a specification section that specifies, based on the fault detection notification, the module from which the fault detection notification has been received first from among the modules; and
an acquisition section that acquires the fault information from the module specified by the specification section.

2. The integrated circuit according to claim 1, wherein the acquisition section issues an instruction to the module specified by the specification section to transmit the fault information; and
the modules individually include:
a first transmission section that transmits the fault information to the fault collection section in accordance with the instruction from the acquisition section.

3. The integrated circuit according to claim 2, wherein the fault collection section includes a decision section that decides a level of the fault from the fault detection notification; and
when it is decided by the decision section that the detected fault has a level equal to or higher than a predetermined threshold value, the acquisition section issues an instruction to the module specified by the specification section to transmit the fault information.

4. The integrated circuit according to claim 3, wherein the modules individually include:
a first retention section that retains the fault information;
the first transmission section transmits the fault information retained by the first retention section to the fault collection section in accordance with the instruction from the acquisition section; and
the fault collection section includes a second retention section that retains the fault information transmitted from the first transmission section.

5. The integrated circuit according to claim 4, wherein the fault collection section includes a second transmission section that transmits, when it is decided by the decision section that the detected fault has a level equal to or higher than the predetermined threshold value, the fault information retained by the second retention section to an external apparatus.

6. The integrated circuit according to claim 1, wherein the fault information generation section generates fault information about a fault detected first in the module by the fault detection section.

7. A fault information processing method for an integrated circuit that includes a fault collection section and a plurality of modules, wherein each of the modules executes:
detecting a fault in the module;
generating, when a fault is detected upon the fault detection, fault information about the detected fault; and
issuing, when a fault is detected upon the fault detection, a fault detection notification indicating that a fault is detected to the fault collection section; and
the fault collection section executes:
specifying, based on the fault detection notification, the module from which the fault detection notification is issued first from among the modules; and
acquiring the fault information from the module specified upon the specification.

8. The fault information processing method according to claim 7, wherein, upon the acquisition, an instruction is issued to the module specified upon the specification to transmit the fault information; and
each of the modules further executes transmitting the fault information to the fault collection section in accordance with the instruction issued upon the acquisition.

9. The fault information processing method according to claim 8, wherein the fault collection section further executes deciding a level of the fault from the fault detection notification; and
when it is decided upon the decision that the detected fault has a level equal to or higher than a predetermined threshold value, upon the acquisition, an instruction is issued to the module specified upon the specification to transmit the fault information.

10. The fault information processing method according to claim 9, wherein each of the modules further executes retaining the fault information;
upon the transmission, the fault information retained upon the retention is transmitted to the fault collection section in accordance with the instruction issued upon the acquisition; and
the fault collection section executes retaining the fault information transmitted upon the transmission.

11. The fault information processing method according to claim 7, wherein, upon the fault information generation, fault information about a fault detected first in the module upon the fault detection is generated.

12. A fault information collection apparatus that collects a fault from a plurality of modules each including a fault detection section that detects a fault, a fault information generation section that generates, when a fault is detected by the fault detection section, fault information about the detected fault, and a notification section that issues, when a fault is detected by the fault detection section, a fault detection notification indicating that a fault is detected to a fault collection section, the fault information collection apparatus comprising:
a specification section that specifies, based on the fault detection notification, the module from which the fault detection notification is received first from among the modules; and
an acquisition section that acquires the fault information from the module specified by the specification section.

13. The fault information collection apparatus according to claim 12, wherein the acquisition section issues an instruction to the module specified by the specification section to transmit the fault information.
